(19) United States
(12) Patent Application Publication
(10) Pub. No.: US 2022/0118711 A1
(43) Pub. Date: Apr. 21, 2022

(54) Three-Dimensional Shaping Device And Method For Manufacturing Three-Dimensional Shaped Object

(71) Applicant: Seiko Epson Corporation, Tokyo (JP)

(72) Inventor: Hiroki KOBAYASHI, Hara (JP)

(21) Appl. No.: 17/504,881

(22) Filed: Oct. 19, 2021

(30) Foreign Application Priority Data
Oct. 20, 2020 (JP) 2020-175888

(51) Int. Cl. B29C 64/393; B29C 64/209; B29C 64/241; B29C 64/236; B29C 64/343; B29C 64/106

(52) U.S. Cl. CPC B29C 64/393; B29C 64/209; B29C 64/241; B33Y 10/00; B29C 64/343; B29C 64/106; B29C 64/236

(57) ABSTRACT

A three-dimensional shaping device includes: a plasticizing unit configured to plasticize a material to generate a shaping material; a nozzle; a discharge adjusting unit configured to adjust a discharge amount of the shaping material from the nozzle; a stage on which the shaping material discharged from the nozzle is stacked; and a control unit configured to control the discharge adjusting unit. The discharge adjustment unit includes a discharge adjustment mechanism configured to function to adjust the discharge amount, a photosensor including a light emitting unit and a light receiving unit, and a motor configured to drive the discharge adjustment mechanism. The control unit adjusts the discharge amount by detecting an initial position of the discharge adjustment mechanism based on a detection result of the photosensor, and sliding or rotating the discharge adjustment mechanism from the initial position by controlling the motor.

The present application is based on, and claims priority from JP Application Serial Number 2020-175888, filed Oct. 20, 2020, the disclosure of which is hereby incorporated by reference herein in its entirety.

### BACKGROUND

### 1. Technical Field

The present disclosure relates to a three-dimensional shaping device and a method for manufacturing a three-dimensional shaped object.

### 2. Related Art

There is a three-dimensional shaping device that manufactures a three-dimensional shaped object by discharging, stacking, and curing a plasticized shaping material.

For example, JP-A-2019-81263 describes a three-dimensional shaping device in which a butterfly valve is provided in a flow path of a shaping material. In JP-A-2019-81263, a discharge amount of the shaping material discharged from a nozzle is adjusted by the butterfly valve.

However, in the three-dimensional shaping device of JP-A-2019-81263, in order to detect an initial position of the butterfly valve, it is necessary to actually discharge the shaping material from the nozzle to measure the discharge amount.

### SUMMARY

One aspect of a three-dimensional shaping device according to the present disclosure includes: a plasticizing unit configured to plasticize a material to generate a shaping material; a nozzle; a discharge adjusting unit configured to adjust a discharge amount of the shaping material from the nozzle; a stage on which the shaping material discharged from the nozzle is stacked; and a control unit configured to control the discharge adjusting unit. The discharge adjusting unit includes: a discharge adjustment mechanism functioning to adjust the discharge amount; a photosensor including a light emitting unit and a light receiving unit; and a motor configured to drive the discharge adjustment mechanism, and the control unit adjusts the discharge amount by detecting an initial position of the discharge adjustment mechanism based on a detection result of the photosensor, and sliding or rotating the discharge adjustment mechanism from the initial position by controlling the motor.

One aspect of a method for manufacturing a three-dimensional shaped object according to the present disclosure is a method for manufacturing a three-dimensional shaped object by discharging a shaping material plasticized from a nozzle. The method includes: detecting an initial position of a discharge adjustment mechanism configured to adjust a discharge amount of the shaping material from the nozzle based on a detection result of a photosensor including a light emitting unit and a light receiving unit; and discharging the shaping material from the nozzle by sliding or rotating the discharge adjustment mechanism from the initial position.

### BRIEF DESCRIPTION OF THE DRAWINGS

FIG. 1 is a cross-sectional view schematically showing a three-dimensional shaping device according to the present embodiment.

FIG. 2 is a perspective view schematically showing a flat screw of the three-dimensional shaping device according to the present embodiment.

FIG. 3 is a plan view schematically showing a barrel of the three-dimensional shaping device according to the present embodiment.

FIG. 4 is a perspective view schematically showing a discharge adjusting unit of the three-dimensional shaping device according to the present embodiment.

FIG. 5 is a side view schematically showing the discharge adjusting unit of the three-dimensional shaping device according to the present embodiment.

FIG. 6 is a side view schematically showing the discharge adjusting unit of the three-dimensional shaping device according to the present embodiment.

FIG. 7 is a flowchart for showing processing of a control unit of the three-dimensional shaping device according to the present embodiment.

FIG. 8 is a cross-sectional view schematically showing a three-dimensional shaping device according to a first modification of the present embodiment.

FIG. 9 is a cross-sectional view schematically showing a three-dimensional shaping device according to a second modification of the present embodiment.

FIG. 10 is a cross-sectional view schematically showing a three-dimensional shaping device according to a third modification of the present embodiment.

### DESCRIPTION OF EXEMPLARY EMBODIMENTS

Hereinafter, preferred embodiments of the present disclosure will be described in detail with reference to drawings. The embodiments to be described below do not unduly limit contents of the present disclosure described in the appended claims. Further, all of configurations to be described below are not necessarily essential elements of the present disclosure.

### 1. Three-dimensional Shaping Device

### 1.1 Overall Configuration

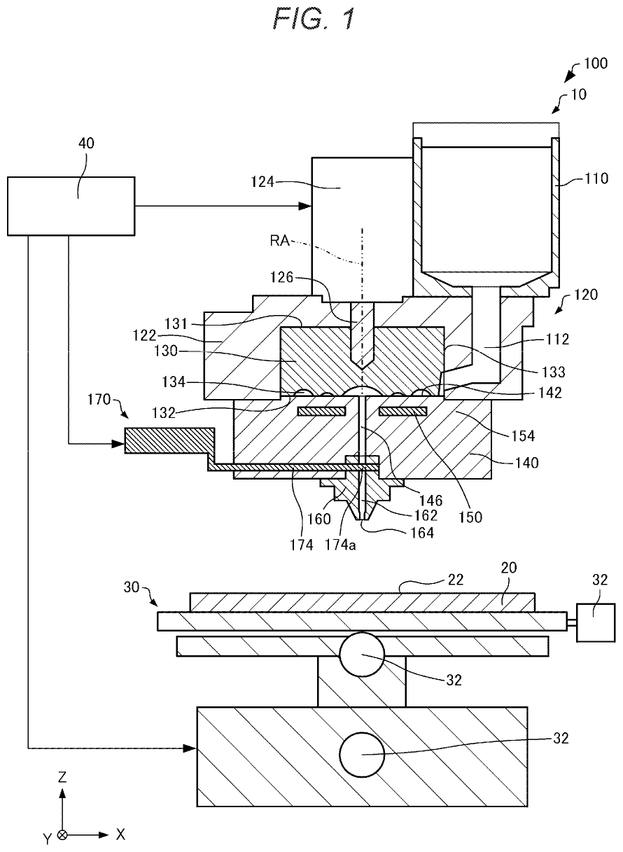

First, a three-dimensional shaping device according to the present embodiment will be described with reference to the drawings. FIG. 1 is a cross-sectional view schematically showing a three-dimensional shaping device 100 according to the present embodiment. FIG. 1 shows an X axis, a Y axis, and a Z axis as three axes orthogonal to each other. An X-axis direction and a Y-axis direction are, for example, horizontal directions. A Z-axis direction is, for example, a vertical direction.

As shown in FIG. 1, the three-dimensional shaping device 100 includes, for example, a shaping unit 10, a stage 20, a moving mechanism 30, and a control unit 40.

The three-dimensional shaping device 100 drives the moving mechanism 30 to change a relative position between a nozzle 160 and the stage 20 while discharging a plasticized shaping material from the nozzle 160 of the shaping unit 10 onto the stage 20. Accordingly, the three-dimensional shaping device 100 shapes a three-dimensional shaped object having a desired shape on the stage 20. A detailed configuration of the shaping unit 10 will be described later.

The stage 20 is moved by the moving mechanism 30. The shaping material discharged from the nozzle 160 is stacked on a shaping surface 22 of the stage 20 to form the three-dimensional shaped object. The shaping material may be directly stacked on the shaping surface 22 of the stage 20, and a sample plate may be disposed on the stage 20 and the three-dimensional shaped object may be formed on the sample plate. In this case, a shaped object material is stacked on the stage 20 via the sample plate.

The moving mechanism 30 changes a relative position between the shaping unit 10 and the stage 20. In the shown example, the moving mechanism 30 moves the stage 20 with respect to the shaping unit 10. The moving mechanism 30 is implemented by, for example, a three-axis positioner that moves the stage 20 in the X-axis direction, the Y-axis direction, and the Z-axis direction by drive forces of three motors 32. The motors 32 are controlled by the control unit 40.

The moving mechanism 30 may be configured to move the shaping unit 10 without moving the stage 20. Alternatively, the moving mechanism 30 may be configured to move both the shaping unit 10 and the stage 20.

The control unit 40 is implemented by, for example, a computer including a processor, a main storage device, and an input and output interface for inputting a signal from an outside and outputting a signal to the outside. The control unit 40 exerts various functions by, for example, executing, by the processor, a program read into the main storage device. The control unit 40 controls the shaping unit 10 and the moving mechanism 30. Specific processing of the control unit 40 will be described later. The control unit 40 may be implemented by a combination of a plurality of circuits instead of the computer.

### 1.2. Shaping Unit

As shown in FIG. 1, the shaping unit 10 includes, for example, a material feeding unit 110, a plasticizing unit 120, and the nozzle 160.

A pellet-shaped or a powder-shaped material is fed into the material feeding unit 110. Examples of the material fed into the material feeding unit 110 include acrylonitrile butadiene styrene (ABS). The material feeding unit 110 is implemented by, for example, a hopper. The material feeding unit 110 and the plasticizing unit 120 are coupled by a supply path 112 provided below the material feeding unit 110. The material fed into the material feeding unit 110 is supplied to the plasticizing unit 120 via the supply path 112.

The plasticizing unit 120 includes, for example, a screw case 122, a drive motor 124, a flat screw 130, a barrel 140, and a heating unit 150. The plasticizing unit 120 plasticizes the material in a solid state supplied from the material feeding unit 110, generates a paste-shaped shaping material having fluidity, and supplies the shaping material to the nozzle 160.

The term “plasticization” is a concept including melting, and means changing from a solid state to a fluid state. Specifically, in a case of a material in which glass transition occurs, the plasticization means raising a temperature of the material to a glass transition point or higher. In a case of a material in which the glass transition does not occur, the plasticization means raising the temperature of the material to a melting point or higher.

The screw case 122 is a housing in which the flat screw 130 is accommodated. The barrel 140 is provided at a lower surface of the screw case 122. The flat screw 130 is accommodated in a space surrounded by the screw case 122 and the barrel 140.

The drive motor 124 is provided at an upper surface of the screw case 122. A shaft 126 of the drive motor 124 is coupled to an upper surface 131 of the flat screw 130. The drive motor 124 is controlled by the control unit 40. The shaft 126 of the drive motor 124 and the upper surface 131 of the flat screw 130 may be coupled to each other via a speed reducer.

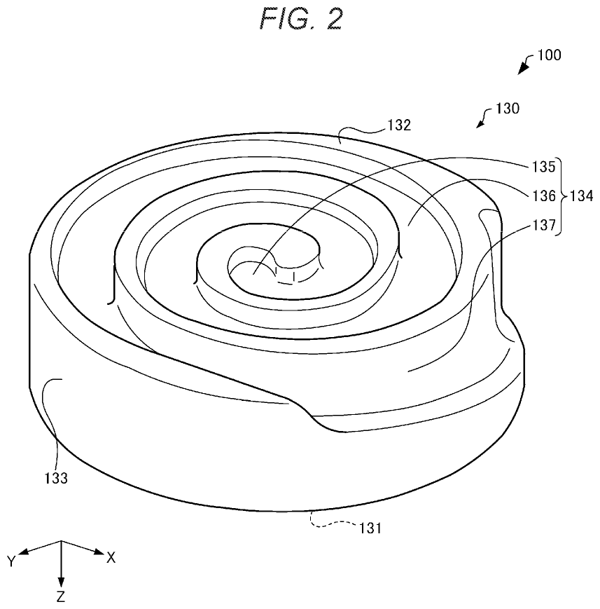

The flat screw 130 has a substantially cylindrical shape in which a size in a direction of a rotation axis RA is smaller than a size in a direction orthogonal to the direction of the rotation axis RA. In the shown example, the rotation axis RA is parallel to the Z axis. The flat screw 130 rotates about the rotation axis RA by a torque generated by the drive motor 124. The flat screw 130 includes the upper surface 131, a groove forming surface 132 on a side opposite to the upper surface 131, and a side surface 133 coupling the upper surface 131 and the groove forming surface 132. The groove forming surface 132 is provided with a first groove 134. Here, FIG. 2 is a perspective view schematically showing the flat screw 130. For convenience, FIG. 2 shows a state in which an upper-lower positional relationship is reversed from a state shown in FIG. 1. Further, FIG. 1 shows the flat screw 130 in a simplified manner.

As shown in FIG. 2, the first groove 134 is provided in the groove forming surface 132 of the flat screw 130. The first groove 134 includes, for example, a central portion 135, a groove coupling portion 136, and a material introduction portion 137. The central portion 135 faces a communication hole 146 provided in the barrel 140. The central portion 135 communicates with the communication hole 146. The groove coupling portion 136 couples the central portion 135 and the material introduction portion 137. In the shown example, the groove coupling portion 136 is provided in a spiral shape from the central portion 135 toward an outer periphery of the groove forming surface 132. The material introduction portion 137 is provided on the outer periphery of the groove forming surface 132. That is, the material introduction portion 137 is provided in the side surface 133 of the flat screw 130. The material supplied from the material feeding unit 110 is introduced from the material introduction portion 137 into the first groove 134, passes through the groove coupling portion 136 and the central portion 135, and is conveyed to the communication hole 146 provided in the barrel 140. The number of the first grooves 134 is not particularly limited, and two or more first grooves 134 may be provided.

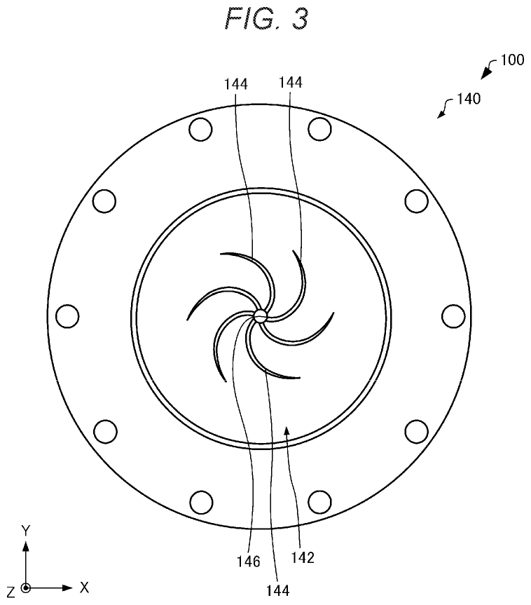

As shown in FIG. 1, the barrel 140 is provided under the flat screw 130. The barrel 140 has a facing surface 142 facing the groove forming surface 132 of the flat screw 130. The communication hole 146 communicating with the first groove 134 is provided at a center of the facing surface 142. Here, FIG. 3 is a plan view schematically showing the barrel 140. For convenience, FIG. 1 shows the barrel 140 in a simplified manner.

As shown in FIG. 3, the facing surface 142 of the barrel 140 is provided with second grooves 144 and the communication hole 146. The plurality of second grooves 144 are provided. In the shown example, six second grooves 144 are provided, and the number of the second grooves is not particularly limited. The plurality of second grooves 144 are provided around the communication hole 146 when viewed from the Z-axis direction. One end of each of the second grooves 144 is directly coupled to the communication hole 146, and the second grooves 144 extend from the communication hole 146 toward the outer periphery of the facing surface 142 in the spiral shape. The second groove 144 has a function of guiding the shaping material to the communication hole 146.

A shape of the second groove 144 is not particularly limited, and may be, for example, a straight line shape. One end of each of the second grooves 144 may not be directly coupled to the communication hole 146. Further, the second grooves 144 may not be provided in the facing surface 142. However, considering that the shaping material is effectively guided to the communication hole 146, the second grooves 144 is preferably provided in the facing surface 142.

The heating unit 150 heats the material supplied between the flat screw 130 and the barrel 140. In the example shown in FIG. 1, the heating unit 150 is provided at the barrel 140. The heating unit 150 is, for example, a heater. An output of the heating unit 150 is controlled by the control unit 40. The plasticizing unit 120 generates the shaping material by heating the material while conveying the material toward the communication hole 146 by the flat screw 130, the barrel 140, and the heating unit 150, and causes the generated shaping material to flow out from the communication hole 146 to the nozzle 160.

The nozzle 160 is provided under the barrel 140. The nozzle 160 discharges the shaping material supplied from the plasticizing unit 120 toward the stage 20. The nozzle 160 is provided with a nozzle flow path 162 and a nozzle hole 164. The nozzle flow path 162 communicates with the communication hole 146. The nozzle hole 164 communicates with the nozzle flow path 162. The nozzle hole 164 is an opening provided at a tip end of the nozzle 160. A planar shape of the nozzle hole 164 is, for example, a circle. The shaping material supplied from the communication hole 146 to the nozzle flow path 162 is discharged from the nozzle hole 164.

### 1.3. Discharge Adjusting Unit

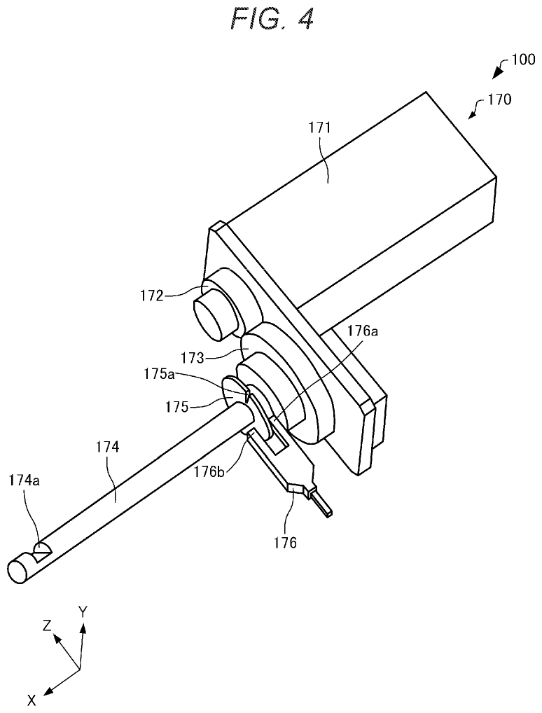

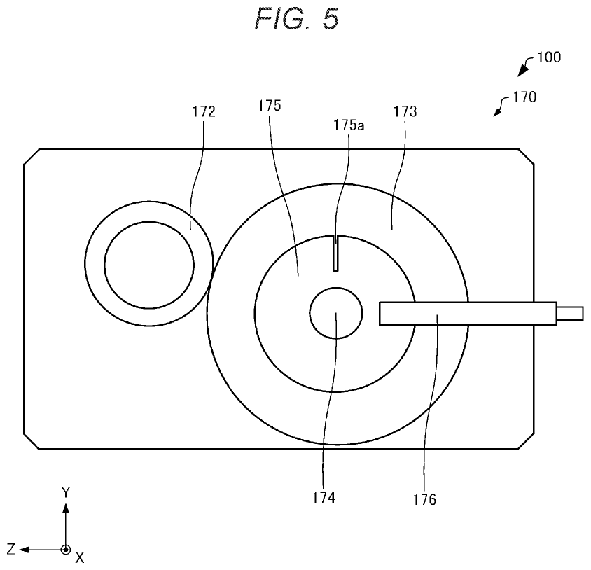

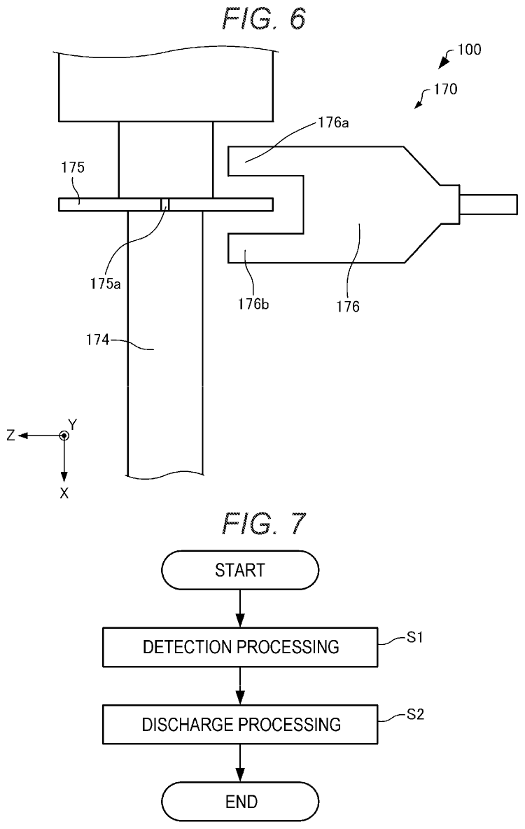

As shown in FIG. 1, the shaping unit 10 further includes a discharge adjusting unit 170. The discharge adjusting unit 170 adjusts a discharge amount of the shaping material from the nozzle 160. Here, FIG. 4 is a perspective view schematically showing the discharge adjusting unit 170. FIGS. 5 and 6 are side views schematically showing the discharge adjusting unit 170. For convenience, FIG. 1 shows the discharge adjusting unit 170 in a simplified manner.

As shown in FIGS. 4 to 6, the discharge adjusting unit 170 includes, for example, a motor 171, an input gear 172, an output gear 173, a discharge adjustment mechanism 174, a slit member 175, and a photosensor 176.

The motor 171 drives the discharge adjustment mechanism 174. The input gear 172 is rotated by the motor 171. In the shown example, the input gear 172 rotates about an axis parallel to the X axis as a rotation axis. The output gear 173 is configured to mesh with the input gear 172. The output gear 173 rotates in conjunction with the rotation of the input gear 172. In the shown example, the output gear 173 rotates about an axis parallel to the X axis as a rotation axis. When viewed from the X-axis direction, a diameter of the output gear 173 is, for example, larger than a diameter of the input gear 172.

The discharge adjustment mechanism 174 is coupled to the output gear 173. The discharge adjustment mechanism 174 functions to adjust the discharge amount of the shaping material from the nozzle 160. The discharge adjustment mechanism 174 is rotated by the output gear 173. In the shown example, the discharge adjustment mechanism 174 is a butterfly valve in which a cutout 174a is provided in a rod-shaped member. As shown in FIG. 1, the cutout 174a is located in the nozzle flow path 162. The discharge adjustment mechanism 174 rotates, for example, about an axis parallel to the X axis as a rotation axis. The rotation of the discharge adjustment mechanism 174 changes an overlapping area between the cutout 174a and the nozzle hole 164 when viewed from the Z-axis direction. Accordingly, the discharge adjustment mechanism 174 can adjust the discharge amount of the shaping material discharged from the nozzle 160.

Although not shown, the cutout 174a of the discharge adjustment mechanism 174 which is the butterfly valve may be located in the communication hole 146 provided in the barrel 140 instead of the nozzle flow path 162.

As shown in FIGS. 4 to 6, the slit member 175 is coupled to, for example, the discharge adjustment mechanism 174. The slit member 175 rotates in conjunction with the rotation of the discharge adjustment mechanism 174. The slit member 175 is configured by providing a slit 175a in a circular member when viewed from the X-axis direction. In the shown example, the number of the slit 175a is one. The slit member 175 may be a slit cam.

The photosensor 176 is provided so as to sandwich the slit member 175. In the shown example, the photosensor 176 is located in a +X-axis direction with respect to the output gear 173. The photosensor 176 is provided on the output gear 173 side. That is, a distance between the photosensor 176 and the output gear 173 is smaller than a distance between the photosensor 176 and the input gear 172. In the shown example, the photosensor 176 overlaps the output gear 173 when viewed from the X-axis direction.

The photosensor 176 includes a light emitting unit 176a and a light receiving unit 176b. The slit member 175 is provided between the light emitting unit 176a and the light receiving unit 176b. When the slit 175a is located between the light emitting unit 176a and the light receiving unit 176b, a light emitted from the light emitting unit 176a passes through the slit 175a and is received by the light receiving unit 176b. In contrast, when the slit 175a is not located between the light emitting unit 176a and the light receiving unit 176b, the light emitted from the light emitting unit 176a is blocked by the slit member 175 and is not received by the light receiving unit 176b. The photosensor 176 can detect a position of the discharge adjustment mechanism 174 via the slit member 175. When the slit member 175 is located between the light emitting unit 176a and the light receiving unit 176b, a positional relationship between the light emitting unit 176a and the light receiving unit 176b may be reversed.

The light emitting unit 176a of the photosensor 176 is constituted with, for example, a light emitting diode. The light receiving unit 176b is configured with, for example, an integrated circuit including a phototransistor. The photosensor 176 may be a photo interrupter.

### 1.4. Control Unit

The control unit 40 controls the discharge adjusting unit 170. FIG. 7 is a flowchart for showing processing of the control unit 40.

For example, a user operates an operation unit (not shown) to output a processing start signal for starting the processing to the control unit 40. The operation unit is implemented by, for example, a mouse, a keyboard, a touch panel, and the like. when receiving the processing start signal, the control unit 40 starts the processing.

As shown in FIG. 7, in step S1, the control unit 40 performs detection processing of detecting an initial position of the discharge adjustment mechanism 174 based on a detection result of the photosensor 176.

Specifically, the control unit 40 drives the photosensor 176 while driving the motor 171 to rotate the discharge adjustment mechanism 174. Then, the control unit 40 detects the initial position of the discharge adjustment mechanism 174 based on presence or absence of light reception in the light receiving unit 176b of the photosensor 176. More specifically, the control unit 40 detects a position at which the light receiving unit 176b receives the light from the light emitting unit 176a as the initial position of the discharge adjustment mechanism 174. The initial position of the discharge adjustment mechanism 174 is a position at which the slit 175a is disposed between the light emitting unit 176a and the light receiving unit 176b. At the initial position of the discharge adjustment mechanism 174, for example, the overlapping area between the cutout 174a and the nozzle hole 164 is maximized when viewed from the Z-axis direction. When the control unit 40 detects the initial position of the discharge adjustment mechanism 174, the control unit 40 stops driving the motor 171 and the photosensor 176 and maintains the discharge adjustment mechanism 174 at the initial position.

Next, in step S2, the control unit 40 performs discharge processing of discharging the shaping material from the nozzle 160 by rotating the discharge adjustment mechanism 174 from the initial position to a predetermined position. Accordingly, the control unit 40 can adjust the discharge amount of the shaping material to be discharged from the nozzle 160.

Specifically, the control unit 40 drives the motor 171 based on shaping data for shaping the three-dimensional shaped object, and rotates the discharge adjustment mechanism 174 from the initial position by a predetermined angle. The shaping data is generated by, for example, slicer software installed in a computer coupled to the three-dimensional shaping device 100. The control unit 40 acquires the shaping data from the computer coupled to the three-dimensional shaping device 100 or a recording medium such as a universal serial bus (USB) memory. When the control unit 40 rotates the discharge adjustment mechanism 174 by the predetermined angle, the control unit 40 stops driving the motor 171.

Next, the control unit 40 drives the shaping unit 10 and the moving mechanism 30 based on the shaping data to discharge a predetermined amount of the shaping material from the nozzle 160. Then, the control unit 40 ends the processing.

The three-dimensional shaped object can be manufactured by a manufacturing process including the above processing.

### 1.5. Operation and Effect

In the three-dimensional shaping device 100, the discharge adjusting unit 170 includes the discharge adjustment mechanism 174 that functions to adjust the discharge amount, the photosensor 176 including the light emitting unit 176a and the light receiving unit 176b, and the motor 171 that drives the discharge adjustment mechanism 174, and the control unit 40 detects the initial position of the discharge adjustment mechanism 174 based on the detection result of the photosensor 176 and controls the motor 171 to rotate the discharge adjustment mechanism 174 from the initial position, thereby adjusting the discharge amount. Therefore, in the three-dimensional shaping device 100, it is not necessary to actually discharge the shaping material from the nozzle 160 in order to detect the initial position of the discharge adjustment mechanism 174, and the initial position of the discharge adjustment mechanism 174 can be automatically detected by the processing of the control unit 40. Accordingly, it is possible to save time and effort of actually discharging the shaping material from the nozzle 160 and detecting the initial position of the discharge adjustment mechanism 174. Further, in the three-dimensional shaping device 100, since the position of the discharge adjustment mechanism 174 is detected using the photosensor 176, the initial position of the discharge adjustment mechanism 174 can be detected without applying an impact to the discharge adjustment mechanism 174.

For example, when the initial position of the discharge adjustment mechanism, which is the butterfly valve, is not detected, the butterfly valve may be displaced from a desired position even when the butterfly valve is rotated by the control unit. Therefore, the discharge amount of the shaping material may vary. In the three-dimensional shaping device 100, since the initial position of the discharge adjustment mechanism 174 can be detected by the control unit 40, the discharge adjustment mechanism 174 can be rotated to the desired position by the control unit 40. Therefore, the above-described problem can be avoided, and the discharge amount of the shaping material can be stabilized.

In the three-dimensional shaping device 100, the discharge adjustment unit 170 includes the slit member 175 provided between the light emitting unit 176a and the light receiving unit 176b, the slit member 175 rotates in conjunction with the operation of the discharge adjustment mechanism 174, and the control unit 40 detects the initial position based on the presence or absence of light reception in the light receiving unit 176b. Therefore, in the three-dimensional shaping device 100, when the light emitted from the light emitting unit 176a passes through the slit 175a and is received by the light receiving unit 176b, the control unit 40 can detect the position of the discharge adjustment mechanism 174 as the initial position.

In the three-dimensional shaping device 100, the discharge adjustment mechanism 174 is the butterfly valve, the discharge adjustment unit 170 includes the input gear 172 rotated by the motor 171 and the output gear 173 rotated in conjunction with the rotation of the input gear 172, the butterfly valve is rotated by the output gear 173, and the photosensor 176 is provided on the output gear 173 side. Therefore, in the three-dimensional shaping device 100, an error between the input gear 172 and the output gear 173 is excluded, and the initial position of the discharge adjustment mechanism 174 can be detected.

In the three-dimensional shaping device 100, the plasticizing unit 120 includes the flat screw 130 having the groove forming surface 132 provided with the first groove 134, and the barrel 140 having the facing surface 142 facing the groove forming surface 132 and provided with the communication hole 146, and the facing surface 142 is provided with the communication hole 146 communicating with the first groove 134. Therefore, in the three-dimensional shaping device 100, for example, it is possible to reduce a size as compared to a case where a rod-shaped in-line screw is used.

The example in which only one slit 175a is provided in the slit member 175 has been described above, but a plurality of slits 175a may be provided in the slit member 175. The slit member 175 may be a rotary encoder provided with the plurality of slits 175a. The slit member 175 may be an absolute rotary encoder. In this case, the control unit 40 detects the initial position and the current position of the discharge adjustment mechanism 174 based on the presence or absence of light reception by the light receiving unit 176b. The current position of the discharge adjustment mechanism 174 is a position of the discharge adjustment mechanism 174 when the discharge processing of discharging the shaping material from the nozzle 160 in step S2 shown in FIG. 7 is performed, and is the rotation angle from the initial position of the butterfly valve when the discharge processing is performed when the discharge adjustment mechanism 174 is the butterfly valve.

Further, when the initial position and the current position of the discharge adjustment mechanism 174 are detected, the control unit 40 may control the discharge adjustment mechanism 174 and the motor 171 based on the current position of the discharge adjustment mechanism 174. Specifically, when there is a difference between the current position of the discharge adjustment mechanism 174 detected by the control unit 40 and an output corresponding to the rotation angle of the motor 171, the control unit 40 applies feedback to the motor 171 so as to eliminate the difference. For example, when the control unit 40 detects that the current position of the discharge adjustment mechanism 174 is 8° and the output of the motor 171 corresponds to the rotation angle of 10° of the discharge adjustment mechanism 174, the control unit 40 applies the feedback such that the output of the motor 171 corresponds to the rotation angle of 8°.

Further, the example in which the control unit 40 detects the initial position of the discharge adjustment mechanism 174 based on the presence or absence of light reception in the light receiving unit 176b has been described above, but the control unit 40 may detect the initial position of the discharge adjustment mechanism 174 based on an intensity of the light received by the light receiving unit 176b. In this case, instead of the slit member 175, a reflection member having regions having different reflectances is provided, and the light from the light emitting unit 176a is reflected by the reflection member and received by the light receiving unit 176b. For example, the control unit 40 detects, as the initial position, a position of the discharge adjustment mechanism 174 when the intensity of the light received by the light receiving unit 176b exceeds a predetermined value.

Further, the example in which the position of the discharge adjustment mechanism 174 is detected as the initial position when the light emitted from the light emitting unit 176a passes through the slit 175a and is received by the light receiving unit 176b has been described. Conversely, when the light emitted from the light emitting unit 176a is blocked by the slit member 175 and is not received by the light receiving unit 176b, the position of the discharge adjustment mechanism 174 may be detected as the initial position.

Further, in the above-described example, the flat screw 130 whose size in the direction of the rotation axis RA is smaller than the size in the direction orthogonal to the direction of the rotation axis RA is used as the screw, but a rod-shaped in-line screw that is long in the direction of the rotation axis RA may be used instead of the flat screw 130.

### 2. Modification

### 2.1. First Modification

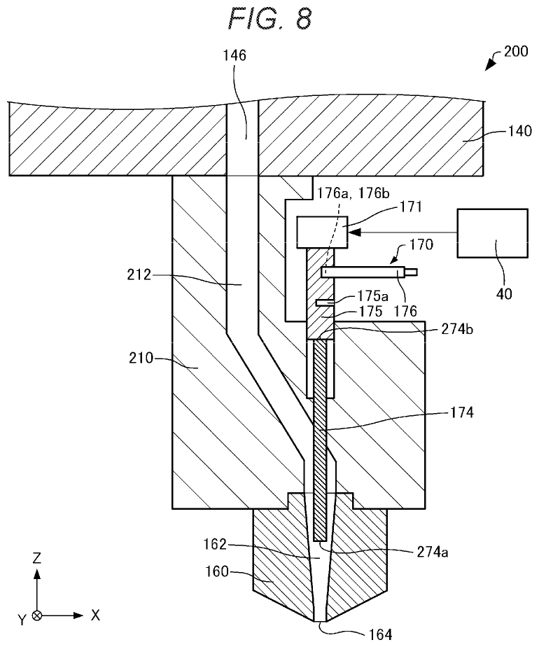

Next, a three-dimensional shaping device according to a first modification of the present embodiment will be described with reference to the drawings. FIG. 8 is a cross-sectional view schematically showing a three-dimensional shaping device 200 according to a first modification of the present embodiment. For convenience, FIG. 8 omits illustration of the stage 20 and the moving mechanism 30.

Hereinafter, in the three-dimensional shaping device 200 according to the first modification of the present embodiment, components having the same functions as those of the three-dimensional shaping device 100 according to the present embodiment are denoted by the same reference numerals, and detailed description thereof will be omitted. This is the same in three-dimensional shaping devices according to second to fourth modifications of the present embodiment to be described below.

In the three-dimensional shaping device 100 described above, as shown in FIG. 4, the discharge adjustment mechanism 174 is a butterfly valve.

In contrast, in the three-dimensional shaping device 200, as shown in FIG. 8, the discharge adjustment mechanism 174 is a closing pin.

The three-dimensional shaping device 200 includes a coupling member 210 that couples the barrel 140 and the nozzle 160. The coupling member 210 is provided with a communication flow path 212 that allows the communication hole 146 and the nozzle flow path 162 to communicate with each other. In the shown example, the communication flow path 212 extends from the communication hole 146 in a −Z axis direction, then extends obliquely with respect to the Z axis, and is coupled to the nozzle flow path 162.

The discharge adjustment mechanism 174, which is the closing pin, is provided in the coupling member 210. The discharge adjustment mechanism 174 is slidable along a Z axis by the motor 171. Although not shown, a moving mechanism for sliding the discharge adjustment mechanism 174 along the Z axis may be provided between the discharge adjustment mechanism 174 and the motor 171.

A tip end 274a of the discharge adjustment mechanism 174 is configured to be able to close the nozzle hole 164. In a state in which the tip end 274a of the discharge adjustment mechanism 174 closes the nozzle hole 164, the shaping material is not discharged from the nozzle hole 164. In contrast, when the tip end 274a of the discharge adjustment mechanism 174 is positioned in a +Z axis direction with respect to the nozzle hole 164, the shaping material is discharged from the nozzle hole 164. In the three-dimensional shaping device 200, a discharge amount of the shaping material discharged from the nozzle hole 164 can be adjusted by sliding the discharge adjustment mechanism 174.

The slit member 175 is provided at a root 274b of the discharge adjustment mechanism 174 which is the closing pin. In the shown example, a size of the slit member 175 in an X-axis direction is larger than a size of the discharge adjustment mechanism 174 in the X-axis direction. For example, when the tip end 274a is located in the +Z-axis direction at a predetermined interval from the nozzle hole 164, the slit 175a is located between the light emitting unit 176a and the light receiving unit 176b of the photosensor 176. The control unit 40 detects a position at which the light receiving unit 176b receives a light from the light emitting unit 176a as an initial position of the discharge adjustment mechanism 174. Then, the control unit 40 adjusts the discharge amount of the shaping material by sliding the discharge adjustment mechanism 174 from the initial position. The slit member 175 slides in conjunction with an operation of discharge adjustment mechanism 174.

Instead of the slit member 175, a reflection member having regions having different reflectances described above may be provided at the root 274b of the discharge adjustment mechanism 174, and the control unit 40 may detect the initial position of the discharge adjustment mechanism 174 based on an intensity of the light received by the light receiving unit 176b.

### 2.2. Second Modification

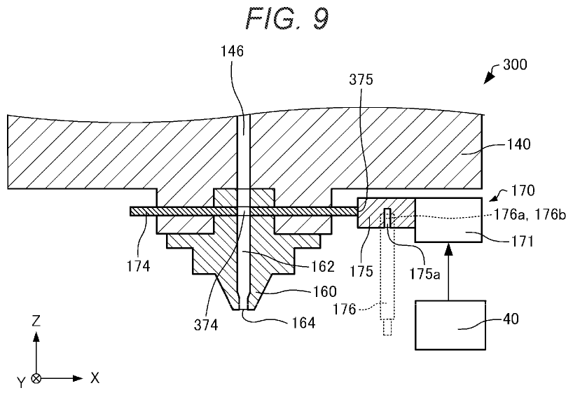

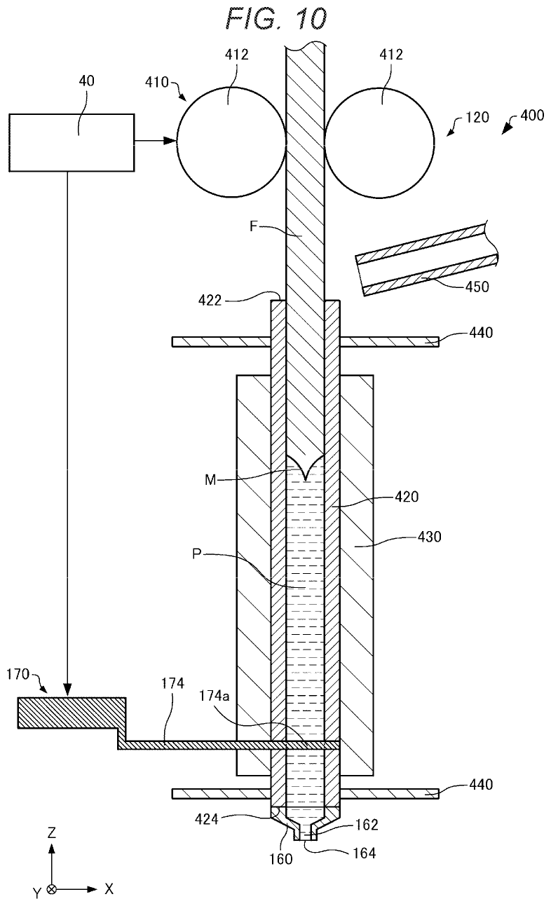

Next, a three-dimensional shaping device according to a second modification of the present embodiment will be described with reference to the drawings. FIG. 9 is a cross-sectional view schematically showing a three-dimensional shaping device 300 according to the second modification of the present embodiment. For convenience, FIG. 9 shows the photosensor 176 in a see-through manner. Further, FIG. 9 omits illustration of the stage 20 and the moving mechanism 30.

In the three-dimensional shaping device 100 described above, as shown in FIG. 4, the discharge adjustment mechanism 174 is a butterfly valve.

In contrast, in the three-dimensional shaping device 300, as shown in FIG. 9, the discharge adjustment mechanism 174 is a shutter.

The discharge adjustment mechanism 174 which is the shutter is slidable along an X axis by the motor 171. Although not shown, a moving mechanism for sliding the discharge adjustment mechanism 174 along the X axis may be provided between the discharge adjustment mechanism 174 and the motor 171.

The discharge adjustment mechanism 174 is provided with a through hole 374 penetrating in an X-axis direction. When viewed from a Z-axis direction, in a state in which the through hole 374 and the nozzle hole 164 overlap each other, a shaping material is discharged from the nozzle hole 164. On the other hand, when viewed from the Z-axis direction, in a state in which the through hole 374 and the nozzle hole 164 do not overlap each other, the shaping material is not discharged from the nozzle hole 164. In the three-dimensional shaping device 300, a discharge amount of the shaping material discharged from the nozzle hole 164 can be adjusted by an overlapping area between the through hole 374 and the nozzle hole 164 when viewed from the Z-axis direction.

The slit member 175 is provided at one end 375 of the discharge adjustment mechanism 174 which is the shutter. For example, when the overlapping area between the through hole 374 and the nozzle hole 164 is the largest as viewed in the Z-axis direction, the slit 175a is located between the light emitting unit 176a and the light receiving unit 176b of the photosensor 176. The control unit 40 detects a position at which the light receiving unit 176b receives a light from the light emitting unit 176a as an initial position of the discharge adjustment mechanism 174. Then, the control unit 40 adjusts the discharge amount of the shaping material by sliding the discharge adjustment mechanism 174 from the initial position. The slit member 175 slides in conjunction with an operation of discharge adjustment mechanism 174.

Instead of the slit member 175, a reflection member having regions having different reflectances described above may be provided at the one end 375 of the discharge adjustment mechanism 174, and the control unit 40 may detect the initial position of the discharge adjustment mechanism 174 based on an intensity of the light received by the light receiving unit 176b.

### 2.3. Third Modification

Next, a three-dimensional shaping device according to a third modification of the present embodiment will be described with reference to the drawings. FIG. 10 is a cross-sectional view schematically showing a three-dimensional shaping device 400 according to the third modification of the present embodiment. For convenience, FIG. 10 omits illustration of the stage 20 and the moving mechanism 30.

As shown in FIG. 1, the three-dimensional shaping device 100 described above includes the flat screw 130 and the barrel 140, and a shaping material is discharged from the nozzle 160 by rotation of the flat screw 130.

In contrast, in the three-dimensional shaping device 400, as shown in FIG. 10, a filament material F in a filament shape is inserted into a plasticizing tube 420, a shaping material P is generated by heat of a heating block 430, and the generated shaping material P is discharged from the nozzle 160. The three-dimensional shaping device 400 is a shaping device using a fused deposition modeling method.

The plasticizing unit 120 of the three-dimensional shaping device 400 includes, for example, a driving mechanism 410, the plasticizing tube 420, the heating block 430, a pair of shield members 440, and a manifold 450.

The filament material F in the filament shape is supplied to the driving mechanism 410 from a material introduction unit (not shown in FIG. 10). The filament material F may be accommodated in a roll shape in the material introduction unit, or may be continuously supplied from the material introduction unit to the driving mechanism 410.

The driving mechanism 410 includes, for example, a pair of wheels 412. The filament material F is supplied between the pair of wheels 412. When the pair of wheels 412 rotate, the filament material F moves in a −Z-axis direction and is inserted into the plasticizing tube 420. The driving mechanism 410 is controlled by the control unit 40.

The heating block 430 is provided around the plasticizing tube 420. The heating block 430 is provided between the pair of shield members 440. That is, the heating block 430 is provided inside the pair of shield members 440. A first end 422 of the plasticizing tube 420 is located outside the pair of shield members 440. The filament material F is inserted into the first end 422. A second end 424 of the plasticizing tube 420 is located outside the pair of shield members 440. The second end 424 is an end opposite to the first end 422. The second end 424 is provided with the nozzle 160.

A heater is built in the heating block 430. The heating block 430 plasticizes the filament material F in the plasticizing tube 420 by heat of the heater. Accordingly, the shaping material P is generated. A meniscus M is formed at a tip end of the filament material F. The movement of the filament material F in the −Z-axis direction functions as a pump for discharging the shaping material P from the nozzle 160. The generated shaping material P is discharged from the nozzle 160 toward a stage (not shown in FIG. 10).

The manifold 450 is provided outside the pair of shield members 440. The manifold 450 sends cooled air toward the first end 422 of the plasticizing tube 420. Accordingly, the filament material F can be prevented from being plasticized outside the pair of shield members 440.

In the plasticizing tube 420, for example, the cutout 174a of the discharge adjustment mechanism 174 which is a butterfly valve is located. The discharge adjustment mechanism 174 adjusts a discharge amount of the shaping material discharged from the nozzle hole 164 by an overlapping area between the cutout 174a and the nozzle hole 164 when viewed from the Z-axis direction.

### 2.4. Fourth Modification

Next, a three-dimensional shaping device according to a fourth modification of the present embodiment will be described. In the three-dimensional shaping device 100 described above, an ABS in a pellet form is used as a material for shaping a three-dimensional shaped object.

In contrast, in the three-dimensional shaping device according to the fourth modification of the present embodiment, examples of a material for shaping the three-dimensional shaped object include materials using various materials such as a thermoplastic material other than the ABS, a metal material, and a ceramic material as a main material. Here, the “main material” refers to a material serving as a main component for forming a shape of the three-dimensional shaped object, and refers to a material having a content of 50 mass % or more in the three-dimensional shaped object. The above-described material includes a material obtained by melting the main material alone or a material obtained by melting the main material and a part of components contained in the main material into a paste shape.

For example, a thermoplastic resin can be used as the thermoplastic material. Examples of the thermoplastic resin include general-purpose engineering plastics such as a polypropylene (PP), a polyethylene (PE), a polyacetal (POM) , a polyvinyl chloride (PVC), a polyamide (PA), an acrylonitrile-butadiene-styrene (ABS), a polylactic acid (PLA), a polyphenylene sulfide (PPS), polycarbonate (PC), modified polyphenylene ether, polybutylene terephthalate, and polyethylene terephthalate, and engineering plastics such as polysulfone, polyether sulfone, polyphenylene sulfide, polyarylate, polyimide, polyamideimide, polyetherimide, and polyether ether ketone (PEEK).

Additives such as a pigment, a metal, a ceramic, a wax, a flame retardant, an antioxidant, and a heat stabilizer may be mixed into the thermoplastic material. In the plasticizing unit 120, the thermoplastic material is plasticized by rotation of the flat screw 130 and heating of the heating unit 150, and is converted into a melted state. Further, after the shaping material generated in this way is discharged from the nozzle 160, the shaping material is cured due to a reduction in a temperature. The thermoplastic material may be discharged from the nozzle 160 in a state in which the material is heated to a temperature of a glass transition point or higher thereof and is melted completely.

In the plasticizing unit 120, for example, the metal material may be used as the main material instead of the thermoplastic material described above. In this case, a component to be melted at the time of generating the shaping material may be mixed into a powder material obtained by converting the metal material into a powder, and then the mixture is fed into the plasticizing unit 120.

Examples of the metal material include a single metal of magnesium (Mg), iron (Fe), cobalt (Co) or chromium (Cr), aluminum (Al), titanium (Ti), copper (Cu), nickel (Ni), or an alloy containing one or more these metals, or maraging steel, stainless steel, cobalt chrome molybdenum, titanium alloy, nickel alloy, aluminum alloy, cobalt alloy, and cobalt chromium alloy.

In the plasticizing unit 120, the ceramic material may be used as the main material instead of the metal material described above. Examples of the ceramic material include an oxide ceramic such as silicon dioxide, titanium dioxide, aluminum oxide, and zirconium oxide, and a non-oxide ceramic such as aluminum nitride.

The powder material of the metal material or the ceramic material fed into the material feeding unit 110 may be a mixed material obtained by mixing a plurality of types of powders of a single metal or an alloy and powders of a ceramic material. Further, the powder material of the metal material or the ceramic material may be coated with, for example, the above-described thermoplastic resin or a thermoplastic resin other than the above-described thermoplastic resin. In this case, the thermoplastic resin may be melted to exhibit fluidity in the plasticizing unit 120.

For example, a solvent can be added to the powder material of the metal material or the ceramic material fed into the material feeding unit 110. Examples of the solvent include water, (poly)alkylene glycol monoalkyl ethers such as ethylene glycol monomethyl ether, ethylene glycol monoethyl ether, propylene glycol monomethyl ether, and propylene glycol monoethyl ether, acetic acid esters such as ethyl acetate, n-propyl acetate, isopropyl acetate, n-butyl acetate, and iso-butyl acetate, aromatic hydrocarbons such as benzene, toluene, and xylene, ketones such as methyl ethyl ketone, acetone, methyl isobutyl ketone, ethyl-n-butyl ketone, diisopropyl ketone, and acetylacetone, alcohols such as ethanol, propanol, and butanol, tetraalkylammonium acetates, sulfoxide-based solvents such as dimethyl sulfoxide and diethyl sulfoxide, pyridine-based solvents such as pyridine, γ-picoline, and 2,6-lutidine, tetraalkylammonium acetates (such as tetrabutylammonium acetate), and ionic liquids such as butyl carbitol acetate.

In addition, for example, a binder may be added to the powder material of the metal material or the ceramic material fed into the material feeding unit 110. Examples of the binder include an acrylic resin, an epoxy resin, a silicone resin, a cellulose-based resin or other synthetic resins or, a polylactic acid (PLA), a polyamide (PA), a polyphenylene sulfide (PPS), a polyether ether ketone (PEEK) or other thermoplastic resins.

The above-described embodiments and modifications are merely examples, and the present disclosure is not limited thereto. For example, it is also possible to appropriately combine each embodiment with each modification.

The present disclosure includes a configuration substantially the same as the configuration described in the embodiment such as a configuration having the same function, method, and result and a configuration having the same object and effect. The present disclosure includes a configuration in which a non-essential portion of the configuration described in the embodiment is replaced. The present disclosure includes a configuration having the same action effect as the configuration described in the embodiment, or a configuration capable of achieving the same object. Further, the present disclosure includes a configuration in which a known technique is added to the configuration described in the embodiment.

The following contents are derived from the above embodiments.

One aspect of a three-dimensional shaping device includes: a plasticizing unit configured to plasticize a material to generate a shaping material; a nozzle; a discharge adjusting unit configured to adjust a discharge amount of the shaping material from the nozzle; a stage on which the shaping material discharged from the nozzle is stacked; and a control unit configured to control the discharge adjusting unit, in which the discharge adjusting unit includes: a discharge adjustment mechanism functioning to adjust the discharge amount; a photosensor including a light emitting unit and a light receiving unit; and a motor configured to drive the discharge adjustment mechanism, and the control unit adjusts the discharge amount by detecting an initial position of the discharge adjustment mechanism based on a detection result of the photosensor, and sliding or rotating the discharge adjustment mechanism from the initial position by controlling the motor.

According to the three-dimensional shaping device, it is not necessary to actually discharge the shaping material from the nozzle in order to detect the initial position of the discharge adjustment mechanism, and the initial position of the discharge adjustment mechanism can be automatically detected by processing of the control unit. Accordingly, it is possible to save time and effort of actually discharging the shaping material from the nozzle and detecting the initial position of the discharge adjustment mechanism.

In the aspect of the three-dimensional shaping device, the discharge adjusting unit may include a slit member provided between the light emitting unit and the light receiving unit, the slit member may slide or rotate in conjunction with an operation of the discharge adjustment mechanism, and the control unit may detect the initial position based on presence or absence of light reception in the light receiving unit.

According to the three-dimensional shaping device, when the light emitted from the light emitting unit passes through the slit and is received by the light receiving unit, the control unit can detect the position of the discharge adjustment mechanism as the initial position.

In the aspect of the three-dimensional shaping device, the slit member may be provided with a plurality of slits, and the control unit may detect a current position of the discharge adjustment mechanism based on the presence or absence of light reception in the light receiving unit.

According to the three-dimensional shaping device, the current position of the discharge adjustment mechanism can be automatically detected by the control unit.

In the aspect of the three-dimensional shaping device, the control unit may control the motor based on the current position.

According to the three-dimensional shaping device, when there is a difference between the current position of the discharge adjustment mechanism detected by the control unit and an output corresponding to a rotation angle of the motor, the control unit can apply feedback to the motor so as to eliminate the difference.

In the aspect of the three-dimensional shaping device, the discharge adjustment mechanism may be a butterfly valve, the discharge adjusting unit may include: an input gear rotated by the motor; and an output gear that rotates in conjunction with the rotation of the input gear, the butterfly valve may be rotated by the output gear, and the photosensor may be provided on an output gear side.

According to the three-dimensional shaping device, an error between the input gear and the output gear can be excluded, and the initial position of the discharge adjustment mechanism can be detected.

In the aspect of the three-dimensional shaping device, the plasticizing unit may include: a screw having a groove forming surface provided with a groove; and a barrel having a facing surface facing the groove forming surface and provided with a communication hole.

According to the three-dimensional shaping device, for example, a size can be reduced as compared to a case where a rod-shaped in-line screw is used.

One aspect of a method for manufacturing a three-dimensional shaped object is a method for manufacturing a three-dimensional shaped object by discharging a shaping material plasticized from a nozzle, the method including: detecting an initial position of a discharge adjustment mechanism configured to adjust a discharge amount of the shaping material from the nozzle based on a detection result of a photosensor including a light emitting unit and a light receiving unit; and discharging the shaping material from the nozzle by sliding or rotating the discharge adjustment mechanism from the initial position.

What is claimed is:

1. A three-dimensional shaping device comprising:
a plasticizing unit configured to plasticize a material to generate a shaping material;
a nozzle;
a discharge adjusting unit configured to adjust a discharge amount of the shaping material from the nozzle;
a stage on which the shaping material discharged from the nozzle is stacked; and
a control unit configured to control the discharge adjusting unit, wherein
the discharge adjusting unit includes:
a discharge adjustment mechanism functioning to adjust the discharge amount;
a photosensor including a light emitting unit and a light receiving unit; and
a motor configured to drive the discharge adjustment mechanism, and
the control unit adjusts the discharge amount by detecting an initial position of the discharge adjustment mechanism based on a detection result of the photosensor, and sliding or rotating the discharge adjustment mechanism from the initial position by controlling the motor.

2. The three-dimensional shaping device according to claim 1, wherein
the discharge adjusting unit includes a slit member provided between the light emitting unit and the light receiving unit,
the slit member slides or rotates in conjunction with an operation of the discharge adjustment mechanism, and
the control unit detects the initial position based on presence or absence of light reception in the light receiving unit.

3. The three-dimensional shaping device according to claim 2, wherein
the slit member is provided with a plurality of slits, and
the control unit detects a current position of the discharge adjustment mechanism based on the presence or absence of light reception in the light receiving unit.

4. The three-dimensional shaping device according to claim 3, wherein
the control unit controls the motor based on the current position.

5. The three-dimensional shaping device according to claim 1, wherein
the discharge adjustment mechanism is a butterfly valve,
the discharge adjusting unit includes:
an input gear rotated by the motor; and
an output gear that rotates in conjunction with the rotation of the input gear,
the butterfly valve is rotated by the output gear, and
the photosensor is provided on an output gear side.

6. The three-dimensional shaping device according to claim 1, wherein
the plasticizing unit includes:
a screw having a groove forming surface provided with a groove; and
a barrel having a facing surface facing the groove forming surface and provided with a communication hole.

7. A method for manufacturing a three-dimensional shaped object for manufacturing a three-dimensional shaped object by discharging a shaping material plasticized from a nozzle comprising:
detecting an initial position of a discharge adjustment mechanism configured to adjust a discharge amount of the shaping material from the nozzle based on a detection result of a photosensor including a light emitting unit and a light receiving unit; and
discharging the shaping material from the nozzle by sliding or rotating the discharge adjustment mechanism from the initial position.
